(19) United States
(12) Patent Application Publication
(10) Pub. No.: US 2017/0315771 A1
(43) Pub. Date: Nov. 2, 2017

(54) SYSTEM AND METHOD FOR SELECTIVELY DISPLAYING IMAGES IN AN AUTONOMOUS VEHICLE

(71) Applicant: Toyota Motor Engineering & Manufacturing North America, Inc., Erlanger, KY (US)

(72) Inventor: Norman C. Kerr, Ann Arbor, MI (US)

(21) Appl. No.: 15/140,790

(22) Filed: Apr. 28, 2016

(51) Int. Cl. G06F 3/14; H04N 7/18; G05D 1/00

(52) U.S. Cl. CPC G06F 3/1446; G05D 1/0088; H04N 7/18

(57) ABSTRACT

Arrangements herein relate to a method and system for selectively displaying surroundings of an autonomous vehicle. The system can include a display to display a plurality of images in which some of the images are images of an environment external to the autonomous vehicle and are images unrelated to the environment external. The system can include cameras to capture the images of the environment external. The system can further include a processor that can be configured to detect a handover event associated with the operation of the vehicle. In response to the detection of the handover event and if the display is displaying images unrelated to the environment external, the processor can also cause the display to display images of the environment external in the place of the images unrelated to the environment external.

### FIELD

The subject matter described herein relates in general to systems for displaying images and more particularly to systems for displaying images in an autonomous vehicle.

### BACKGROUND

Many vehicles include entertainment systems for passengers. For example, nearly all private vehicles come equipped with systems that provide access to various audio components, like CD players, interfaces for accepting digital music from a smartphone, and satellite or high-definition radios. In addition, many automobiles are able to play DVDs and to display the content on small screens embedded in the back of the headrests of the front seats. While these systems enable occupants of the vehicle to enjoy content, the overall experience is inferior compared to home theater systems or other entertainment venues, like movie theaters. Moreover, the driver is unable to view video content because of his need to operate the vehicle. These shortcomings may be even more pronounced in an autonomous vehicle, where the driver may be periodically relieved of concentrating on its overall operation.

### SUMMARY

A system is provided herein for selectively displaying images in an autonomous vehicle, including those of the outside environment of the vehicle and those of multimedia content. The multimedia content can be shown during an autonomous mode, while the display can be switched to show the outside environment when the vehicle requires a handover to manual mode.

An example of such a system is presented herein. The system can include a display that can be configured to display a plurality of images in which at least some of the images may be images of an environment external to the autonomous vehicle and may be images unrelated to the environment external to the autonomous vehicle. The system can also include a processor and one or more cameras that can be configured to capture the images of the environment external to the autonomous vehicle. In addition, the processor can be configured to detect a handover event associated with the operation of the autonomous vehicle. In response to the detection of the handover event and if the display is displaying images unrelated to the environment external to the autonomous vehicle, the processor can be further configured to cause the display to display images of the environment external to the autonomous vehicle in the place of the images unrelated to the environment external to the autonomous vehicle.

Another system for selectively displaying an external environment of an autonomous vehicle is described herein. The system can include one or more cameras that are configured to capture images of the external environment of the autonomous vehicle. The system can also include a processor and a passenger-compartment display that can be configured to selectively display the images of the external environment captured by the cameras and to selectively display multimedia content. The processor can be configured to detect a handover event associated with the operation of the autonomous vehicle that necessitates a form of manual intervention. In response to the detection of the handover event, the processor can be further configured to cause the passenger-compartment display to preempt the display of the multimedia content with the display of the images of the external environment of the autonomous vehicle.

A method of selectively displaying images in an autonomous vehicle is also presented herein. The method can include the steps of capturing images of the external environment of the autonomous vehicle and during an autonomous mode, displaying images of multimedia content on a passenger-compartment display. The method can further include the steps of detecting a handover event that signals at least some manual input from an occupant of the autonomous vehicle and in response to the detection of the handover event, preempting the display of the images of the multimedia content by displaying the images of the external environment of the autonomous vehicle in place of the images of the multimedia content on the passenger-compartment display. The displayed images of the external environment of the autonomous vehicle can be used to operate the autonomous vehicle manually.

### BRIEF DESCRIPTION OF THE DRAWINGS

FIG. 1 is an example of a front view of a passenger compartment of an autonomous vehicle with a display.

FIG. 2 is an example of a rear view of a passenger compartment of an autonomous vehicle with a display.

FIG. 3 is an example of a bird's-eye view of a passenger compartment of an autonomous vehicle with a display.

FIG. 4 is an example of an autonomous vehicle with several cameras positioned on the exterior of the vehicle.

FIG. 5 is an example of a systems layer of an autonomous vehicle.

FIG. 6A is an example of a first view of a portion of a display of a passenger compartment.

FIG. 6B is an example of a second view of the portion of the display of the passenger compartment of FIG. 6A.

FIG. 6C is an example of a view of another portion of the display of the passenger compartment of FIG. 6A.

### DETAILED DESCRIPTION

As explained earlier, current entertainment systems in vehicles are useful but are inferior to the offerings of other multimedia equipment, such as that provided by home theater arrangements. This divide between such systems puts autonomous vehicles at a further disadvantage because the occupants may be faced with lengthy bouts of time during an autonomous mode in which the vehicle does not need their input or attention.

A system for selectively displaying images in an autonomous vehicle is presented herein for improving the travel experiences of the occupants. The system can include a display that can be configured to display a plurality of images. At least some of the images can be images of an environment external to the autonomous vehicle and can be images unrelated to the environment external to the autonomous vehicle. The system can also include a processor and one or more cameras, which can be configured to capture the images of the environment external to the autonomous vehicle. The processor can be configured to detect a handover event associated with the operation of the autonomous vehicle. In response to the detection of the handover event and if the display is displaying images unrelated to the environment external to the autonomous vehicle, the processor can be further configured to cause the display to display images of the environment external to the autonomous vehicle in the place of the images unrelated to the environment external to the autonomous vehicle.

Accordingly, the system can provide a display that can allow an occupant, including the driver, to view, for example, multimedia content, such as during an autonomous mode of operation. In addition, if a handover is required, the display can show images of the outside environment of the vehicle, which the driver can rely on to manually operate the vehicle once the autonomous mode is discontinued. The display can be arranged to run along a significant portion of the passenger compartment, thereby providing a much better viewing experience by the occupants without interfering with the operation of the vehicle during a manual mode.

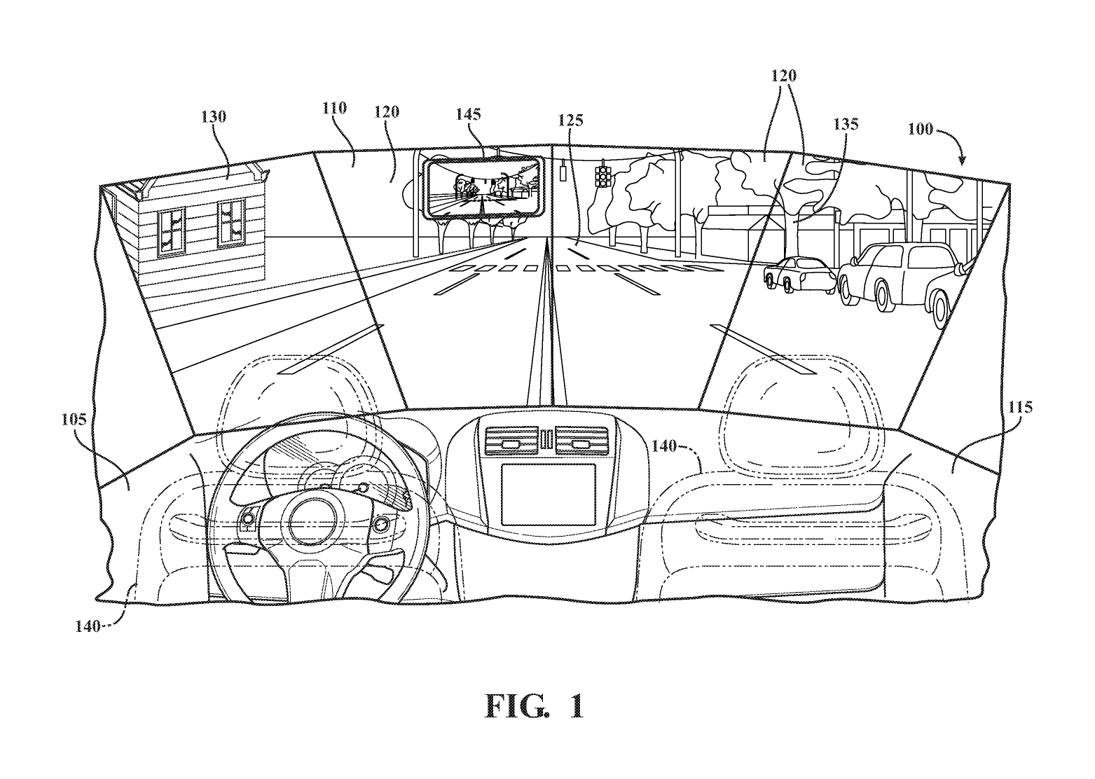

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. Those of skill in the art, however, will understand that the embodiments described herein can be practiced without these specific details.

Several definitions that are applicable here will now be presented. The term “vehicle” is defined as a conveyance that provides transport to humans, animals, machines, cargo, or other objects. An “occupant” is defined as a person, animal, or machine that is transported or transportable by a vehicle. In view of this definition, a person, animal, or machine may be considered an occupant when inside the vehicle or outside the vehicle.

A “processor” is defined as a hardware component or group of hardware components that are configured to execute instructions or are programmed with instructions for execution (or both), and examples include single and multi-core processors and co-processors. The term “communications circuit” is defined as one or more circuit components that are configured to support or otherwise facilitate the exchange of communication signals, including through wired connections, wireless connections, or both. A “memory” or a “memory unit” is defined as a non-transitory hardware structure (along with supporting software or file systems, where necessary for operation) that is configured to store a collection of data that is organized for access. A “camera” is defined as any device, component, and/or system that can capture or record images.

An “autonomous vehicle” is defined as a vehicle that is configured to sense its environment and navigate itself with or without human interaction. An autonomous vehicle may operate in one or more modes, including fully autonomous, semi-autonomous (for example, adaptive cruise control), or manual (for example, human operator has control of the vehicle). The term “operational hazard” is a hazard, danger, or risk, either currently in existence or with the potential of existing, that is involved with the operation of an autonomous vehicle. Examples of an operational hazard include objects in the path of the vehicle, changes in the course of a road on which the vehicle is traveling, malfunctions of components or systems of the vehicle, or certain operational modes of the vehicle. A “display” is defined as an electronic device that is configured to show images or otherwise make them visible.

The term “an environment external to an autonomous vehicle” or “an external environment of an autonomous vehicle” is defined as a setting that exists outside the autonomous vehicle. The term “handover event” is defined as an event that signifies that a transition from one operational mode to another is required, is about to occur, is in the process of occurring, or has already occurred. Other definitions may be presented throughout this document.

Referring to FIG. 1, an example of a system 100 for selectively displaying images in a vehicle 105 is shown. In this example, the vehicle 105 is an automobile, although it may be a motorcycle, an all-terrain vehicle (ATV), a snow mobile, a watercraft, an aircraft, a bicycle, a carriage, a locomotive or other rail car, a go cart, a golf cart or some other mechanized or even biological form of transport. In some cases, the vehicle 105 may be an autonomous vehicle, or a vehicle in which one or more computing systems are used to navigate and/or maneuver the vehicle 105 along a travel route with minimal or no input from a human driver. If the vehicle 105 is capable of autonomous operation, the vehicle 105 may also be configured to switch to a manual mode, or a mode in which a human driver controls most of the navigation and/or maneuvering of the vehicle along a travel route. The vehicle 105 may also operate in semi-autonomous mode in which a human operator maintains primary control of the vehicle 105 but one or more automated systems may assist the human operator.

In one embodiment, the vehicle 105 may include a passenger-compartment display 110 that is part of a passenger compartment 115 of the vehicle 105. As an example, the passenger-compartment display 110 may include a plurality of panels 120, each of which is capable of displaying entire images or portions thereof. For example, each panel 120 can be configured to display images that are distinct from any number of the other panels 120 or can be configured to work in tandem with other panels 120 by displaying a portion of some larger image that projects across multiple panels 120.

In one case, the passenger-compartment display 110 may be positioned along at least a portion of an interior perimeter of the passenger compartment 115. In one particular example, the passenger-compartment display 110 may be positioned along more than a majority of this interior perimeter, including along the entire perimeter. If the passenger-compartment display 110 runs along the entire perimeter of the passenger compartment 115, it may take the form of a wrap-around display, an example of which will be shown below. In view of this feature, the passenger compartment 115 may be devoid of windows or at least may include a number of windows fewer than expected in a conventional vehicle. For example, the passenger compartment 115 may include a front windshield (not shown) but may not include side or rear windows, as the passenger-compartment display 110 may be positioned in their places.

Any number of panels 120 can make up the passenger-compartment display 110. As an example, a greater number of panels 120 may increase the number of separate streams of images that can be displayed and can increase the flexibility of the passenger-compartment display 110 in terms of positioning in the passenger compartment 115.

The passenger-compartment display 110 can be any suitable component for showing various images. Examples include images of an environment external to the vehicle 105 or images unrelated to such an environment, like multimedia content or operational information associated with the operation of the vehicle 105. For example, passenger-compartment display 110 can show structures outside the vehicle 105, like a surface 125 along which the vehicle 105 is traveling or structures 130 or vegetation 135 along the surface 125. These external images can correspond to what the occupants of the vehicle 105 would normally see through a window, such as a front windshield.

In one embodiment, the images of the external environment may have a substantially matching correspondence with the real-life dimensions of the objects in the images, with respect to the positioning of the vehicle 105. In such a case, the occupants may experience the outside environment in a virtual fashion, through one or more video streams, in a way that simulates conventional views through one or more windows. As an option, the images of the external environment may be scaled in any appropriate fashion, such as by increasing or decreasing the size of the objects of the images in comparison to their real-life dimensions. In either arrangement, because the passenger-compartment display 110 can show images of the outside environment, an occupant of the vehicle 105 may rely on the display to operate the vehicle 105, including driving it.

The multimedia images can be any form of content, such as television shows (recorded or live broadcasts), movies, educational or instructional videos, Web pages (including streaming video), maps, electronic books, video games, or video conference calls. The operational information associated with the vehicle 105 can include vehicle parameters, such as speed, engine temperature, direction of travel, or engine or tire pressure warnings. Other suitable forms of content may be shown on the passenger-compartment display 110.

The passenger-compartment display 110 can be constructed with any suitable technology for displaying images. Examples of such technology include liquid crystal display (LCD), digital light processing (DLP), plasma display panel (PDP), liquid crystal on silicon (LCoS), light-emitting diode (LED), organic light-emitting diode (OLED), laser-phosphor display (LPD) and quantum dot LED (QDLED). Of course, other technologies may apply here. As an added (but not required) consideration, a technology that provides displays that are physically flexible may be selected to enable the passenger-compartment display 110 to be easily incorporated into the passenger compartment 115.

The vehicle 105 may be equipped with one or more seats 140 that may be used to support an occupant during operation of the vehicle 105. As an option, the seats 140 may be designed to be positioned in different directions or orientations. For example, in an autonomous mode, the vehicle 105 may operate without any human input or guidance, and the occupants may position the seats 140 to enable the occupants to face one another during this mode. As another example, this feature can permit an occupant to position the seat 140 to face a particular portion of the passenger-compartment display 110, such as a section that runs along the side or rear of the vehicle 105.

In another arrangement, the passenger compartment 115 may include a virtual rear-view mirror 145. Images of the external environment at the rear of the vehicle 105 may be shown on the virtual rear-view mirror 145, which can enable the driver to identify other vehicles or pedestrians behind the vehicle 105. Of course, other images may be shown on the virtual rear-view mirror 145, such as multimedia content or operational information associated with the vehicle 105. In another example, the virtual rear-view mirror 145 may include an actual mirror or other reflective surface for presenting a reflection of a portion of the passenger-compartment display 110 that runs long the rear of the passenger compartment 115. In this example, the driver may see a reflection of the images of the external environment of the vehicle 105 shown by the rear portion of the passenger-compartment display 110. These features presented here may also be integrated into virtual side-view mirrors (not shown), which can be integrated into the interior of the passenger compartment 115, such as where conventional side-view mirrors are typically placed.

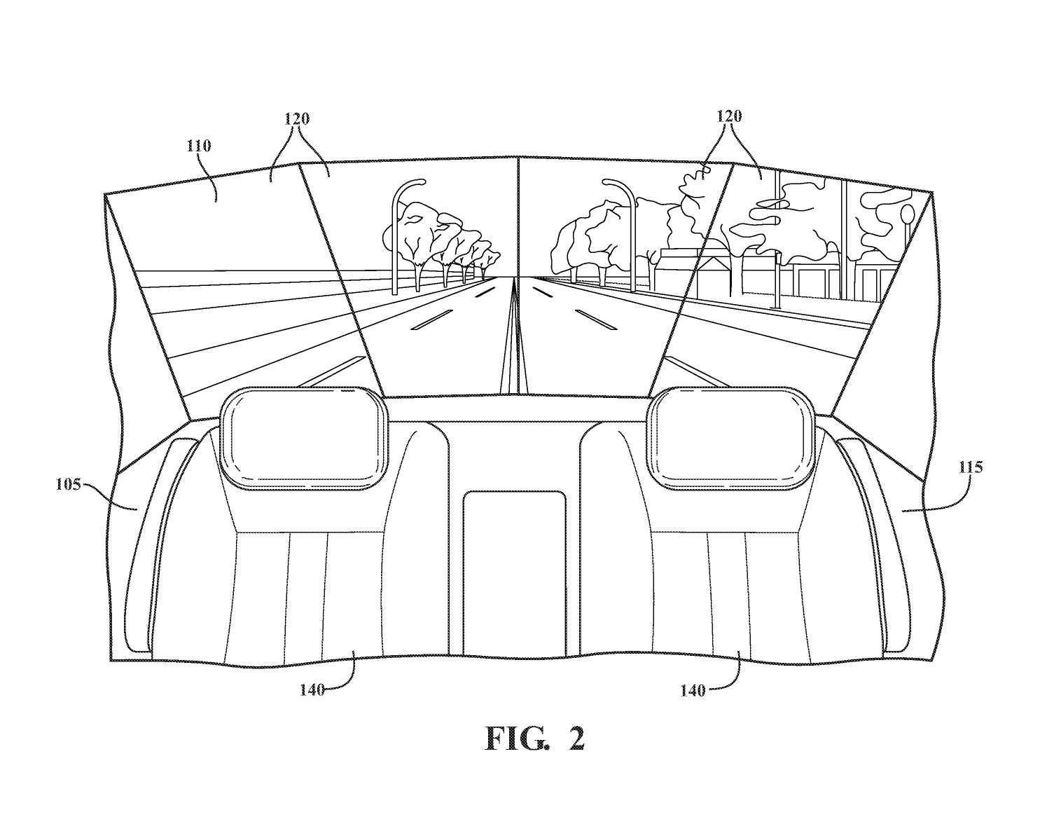

Referring to FIG. 2, a view of the rear of the passenger compartment 115 of the vehicle 105 is shown. One or more rear seats 140 may be part of the rear of the passenger compartment and may be selectively positioned, like those described in reference to FIG. 1. In this arrangement, the passenger-compartment display 110 may be positioned along an inner perimeter of this section of the passenger compartment 115, and the panels 120 may show images that correspond to the external environment at the rear of the vehicle 105. As will be shown later, the passenger-compartment display 110 may be positioned along other portions of the passenger compartment 115, such as the sides of the compartment 115, and the displayed images of the external environment may align with that particular section of the vehicle 105. Other displays may be integrated into the passenger compartment 115, including the roof or floor of the passenger compartment 115, with corresponding external images being capable of being shown on their respective displays 110. For example, a roof display (not shown) may show images of the area above the vehicle 105. Any of these displays may also be configured to show images unrelated to the external environment, including multimedia or operational information images, as described earlier.

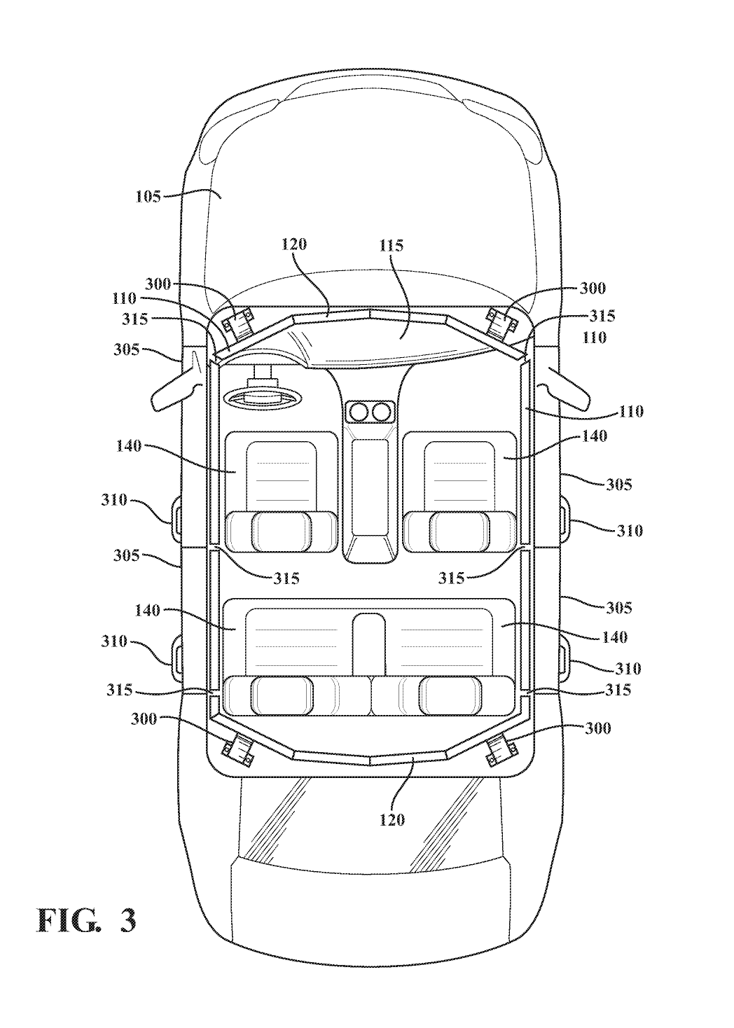

Referring to FIG. 3, a bird's-eye view of the passenger compartment 115 of the vehicle 105 is shown. In this example, the passenger-compartment display 110 can be a wrap-around display, meaning that the display can run along substantially an entire interior perimeter of the passenger compartment 115. To help secure the passenger-compartment display 110, one or more brackets 300 or other supporting structures can attach portions of the passenger-compartment display 110 to the interior of the passenger compartment 115.

As explained above, images that show the external environment of the vehicle 105 may be displayed on the passenger-compartment display 110. In one embodiment, the passenger-compartment display 110 can be segmented into one or more portions, and each portion can, for example, include one or more panels 120. As an example, a first portion of the passenger-compartment display 110 can be positioned in the area where a front windshield would normally be placed. Continuing with this example, second and third portions may be positioned in the areas where driver- and passenger-side windows would normally be, respectively. A fourth portion may be located in the section of the passenger compartment 115 where a rear window would be conventionally situated.

For each of these portions of the passenger-compartment display 110, images from the external environments that correspond to the portions may be shown. For example, images from the front of the vehicle 105 may be displayed on the front portion of the passenger-compartment display 110, or the section of the passenger compartment 115 where the front windshield would normally be. This arrangement can also apply to the second, third, and fourth portions of the passenger-compartment display 110. By displaying such corresponding images on the portions of the passenger-compartment display 110 in this manner, the passenger-compartment display 110 can mimic or simulate what the occupants would see through conventional windows.

The use of panels 120 or by segmenting the passenger-compartment display 110 into a number of portions, different streams of images may also be presented to the occupants. For example, a number of panels 120 or a portion of the passenger-compartment display 110 can be assigned or designated to an occupant, and the occupant may have some control over what is displayed in his assigned section. If the vehicle 105 is being manually operated, the images that are shown in each occupant's assigned section may be images of the environment external to the vehicle 105. If, however, the vehicle 105 is being operated in an autonomous mode, the occupant may select other images to be shown on the assigned section, like multimedia images. In this configuration, the occupants may choose to watch, for example, movies or television shows that are different from those that another occupant may be watching on her designated section of the passenger-compartment display 110.

This assignment of sections of the passenger-compartment display 110 to occupants can be flexible in nature, as any number of sections (i.e., panels 120 and/or portions) may be designated for any number of occupants. For example, if four occupants are in the vehicle 105, the passenger-compartment display 110 can be segmented into four different sections, each under the selective control of an occupant. The sections may be equal to one another in size or viewing area, but not necessarily so. To increase the comfort of the occupants, the seats 140 of the passenger compartment 115 may be rotated and/or positioned in any suitable manner. For example, the rear seats 140 may be rotated to enable the occupants seated in them to comfortably view the part of the passenger-compartment display 110 in that area of the passenger compartment 115.

As will be explained below, if images unrelated to the outside environment of the vehicle 105 are being shown on any section of the passenger-compartment display 110, the passenger-compartment display 110 can be selectively manipulated to interrupt the currently displayed images to show images of the outside environment. This switching of the type of images being shown can enable a driver to easily resume manual operation of the vehicle 105, if needed.

The vehicle 105 may be equipped with one or more doors 305 to enable the occupants to enter and exit the passenger compartment 115, such as through the use of door handles 310. To accommodate the operation of the doors 305, the passenger-compartment display 110 may include any number of gaps 315 that can be strategically positioned to permit the passenger compartment display 110 to move with the doors 305 as they are opened or closed. In some cases, these gaps 315 can include structures that permit rotation, like hinges, to allow the movement of the passenger-compartment display 110 when the doors 305 are operated. This feature can be applied to other relevant components of the passenger compartment 115, like storage compartments.

As noted earlier, the passenger compartment 115 may or may not include windows. In one embodiment, the passenger-compartment display 110 may be mounted in front of some or all the windows of the passenger compartment 115 (from the perspective of the occupants). In such a case, the passenger-compartment display 110 may be constructed of a substantially transparent material, which can permit an occupant to see through the passenger-compartment display 110, such as when no images are being shown on the passenger-compartment display 110. In another example, the images that are being shown on the passenger-compartment display 110 may have their transparency adjusted, such as being increased for better quality images or by being decreased to allow the occupants to see (partially) through the passenger-compartment display 110. In addition, if one or more side windows are part of the passenger compartment 115, the sections of the passenger-compartment display 110 positioned over the side windows may be configured to be raised or lowered in conjunction with the side windows. In fact, this feature may apply to other windows that may be opened or closed. In another embodiment, at least some windows may not be present, and the relevant sections of the passenger-compartment display 110 may still be moved to enable some other opening, such as a hatch with no glass, to be opened and closed.

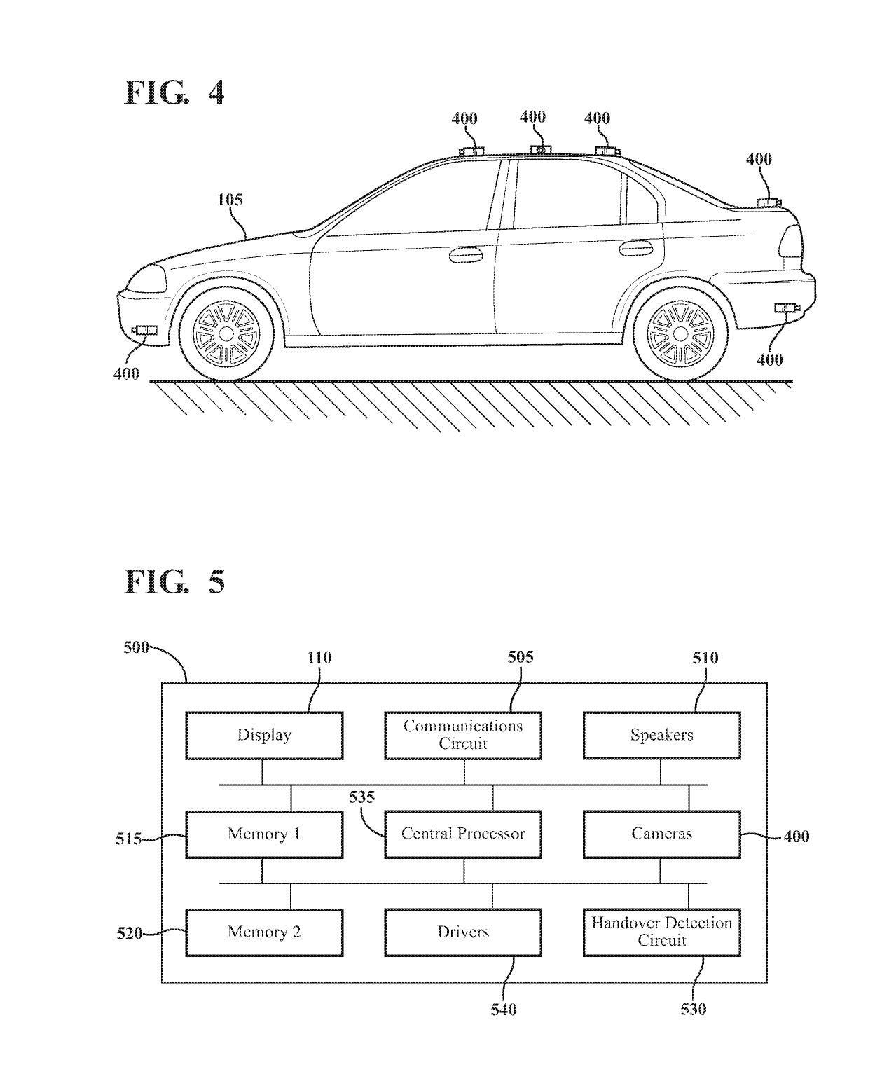

Referring to FIG. 4, an example of the vehicle 105 is shown in which the vehicle 105 is equipped with one or more cameras 400. The cameras 400 can be positioned along any suitable portion of the vehicle 105 to enable the cameras 400 to capture images of the outside environment. As an example, one or more cameras 400 may feed video signals to a section of the passenger-compartment display 110 that corresponds to the area of the outside environment to be displayed on that section. For example, the cameras 400 that take video of the front of the vehicle 105 may provide video streams to the section of the passenger-compartment display 110 that is placed in the area where the front windshield would normally be.

In one embodiment, one or more of the cameras 400 may include the ability to adjust its magnification when capturing images (i.e., zoom-in or zoom-out). Moreover, the cameras 400 may be in fixed positions or may be pivotable or repositioned on the vehicle 105. Although the cameras 400 are shown on the exterior of the vehicle 105, one or more of them may be positioned inside the passenger compartment 115, with appropriate accommodations made to allow the cameras 400 to have substantially unobstructed views of the outside environment.

Referring to FIG. 5, an example of a block diagram of a systems layer 500 is illustrated. The systems layer 500 may be representative of and may include at least some of the components described in reference to FIGS. 1-4, although the systems layer 500 is not necessarily limited to those components. The description associated with FIG. 5 may expand on some of the components and processes presented in the discussion of FIGS. 1-4, although the additional explanations here are not meant to be limiting.

In one arrangement, the systems layer 500 can include any number of hardware and software components to enable the operation of at least some features of the vehicle 105. As an example, the systems layer 500 can include the passenger-compartment display 110, a communications circuit 505, a set of speakers 510, a first memory 515, a second memory 520, a handover-detection circuit 530, a central processor 535, a set of drivers 540, and the cameras 400. Although not shown here, the systems layer 500 can include or be configured to interact with any number of abstraction layers to support and facilitate communications with higher levels of the vehicle 105.

The communications circuit 505 can include any suitable number and type of components for conducting communications in accordance with a specific frequency (or range of frequencies) and/or one or more particular communication protocols. For example, the communications circuit 505 may be configured to conduct satellite communications, which can be used to support GPS or other directional assistance systems. As another example, the communications circuit 505 may be designed for Bluetooth, Near Field Communication (NFC) or Wi-Fi communications, relatively short-range protocols that enable wireless communications with other communications equipment associated with the operation of the vehicle 105. The communications circuit 505 may also be set up to facilitate wireless communications over a cellular network (not shown), which can enable a user to make voice calls and perform data exchanges over such wide-area networks. An occupant may also conduct wide-area network communications through a portable computing device (not shown) when the device is docked with the communications circuit 505, either through a hard-wired or wireless connection. Other protocols and types of communications may be supported by the communications circuit 505, as the vehicle 105 is not limited to these particular examples described here.

The speakers 510 may also be used to broadcast any relevant audio, including warnings. This output may supplement the information shown by the passenger-compartment display 110, or it may be in lieu of the images being displayed. The term “speaker” is defined as one or more devices, components, or systems that produce sound, whether audible to humans or not, in response to an audio signal input. In addition to providing warnings, the speakers 510 may broadcast sounds related to other functions of the vehicle 105, such as audible directions from a GPS or music from a stereo system.

The first memory 515 and the second memory 520 can include any number and type of hardware units for storing data. As an example, the first memory units 515 and the second memory 520 may non-transitively store instructions and other programs to enable at least some of the components, devices, and systems of the vehicle 105 to perform their functions. As an example, the first memory 515 can be volatile memory, and the second memory 520 can be non-volatile memory. Suitable examples for the first memory 515 and the second memory 520 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The first memory 515 and/or the second memory 520 may be a component of the central processor 535, or the first memory 515 and/or the second memory 520 can be communicatively connected to the central processor 360 (and any other suitable devices) for use thereby.

The handover-detection circuit 530 can include any number of components for detecting a handover event associated with the operation of the vehicle 105. A “handover event” is defined as any event that indicates a shift to manual mode is desired or required or that at least some input or control over the vehicle 105 from a human is desired or required. For example, various sensors (not shown) of the vehicle 105 may detect obstacles in the travel path of the vehicle 105 or a loss of positional information from a GPS. This information may be provided to the handover-detection circuit 530, which can generate a signal that is indicative of a handover event. In one embodiment, the handover-detection circuit 530 may forward this signal to the central processor 535 to enable additional actions to be taken in response to the handover event.

The central processor 535 can be configured to exchange signals with any number of systems or components of the vehicle 105 and can execute programs or other instructions to process the received data. The central processor 535 may request additional data from other resources and can provide output to the other devices of the systems layer 500 or other systems of the vehicle 105.

Any suitable architecture or design may be used for the central processor 535. For example, the central processor 535 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software. Further examples of suitable processors include, but are not limited to, an array processor, a vector processor, a field-programmable gate array (FPGA), a programmable logic array (PLA), an application specific integrated circuit (ASIC), and programmable logic circuitry. The central processor 535 can include at least one hardware circuit (e.g., an integrated circuit) configured to carry out instructions contained in program code.

In arrangements in which there is a plurality of central processors 535, such processors can work independently from each other or one or more processors can work in combination with each other. In one or more arrangements, the central processor 535 can be a main processor of the systems layer 500 or the vehicle 105. This description about processors may apply to any other processor that may be part of any system or component described herein.

The drivers 540 can be software modules to enable any of the devices of the systems layer 500 to communicate with higher level layers. For example, the passenger-compartment display 110 can include any number of drivers to facilitate its operation, such as the feature of showing many different images simultaneously.

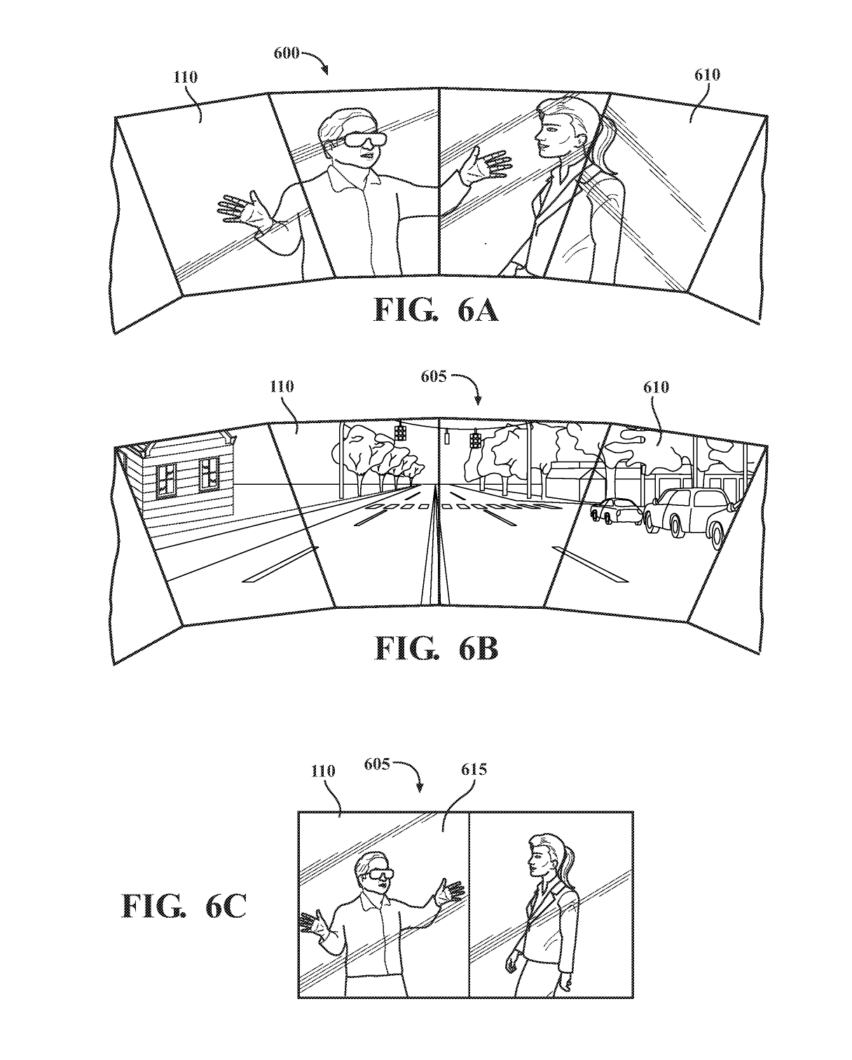

As explained earlier, the passenger-compartment display 110 has the ability to selectively display images of the outside environment of the vehicle 105 and images unrelated to the outside environment, such as multimedia content or operational information. An example of this feature in operation will be presented in relation to FIGS. 6A-6C, which present several examples of what the occupants of the vehicle 105 may see displayed by the passenger-compartment display 110 during different modes of operation of the vehicle 105. These different examples are referred to as “views” in the description below. To help describe FIGS. 6A-6C, reference may be made to some of the components and systems presented in relation to FIGS. 1-5.

Referring to FIG. 6A, a first view 600 of a portion 610 of the passenger-compartment display 110 is shown. In this example, the portion 610 of the passenger-compartment display 110 may be positioned in an area of the passenger compartment 115 where a front windshield would normally be placed. Also in this example, the vehicle 105 may be operating in autonomous mode, and the first view 600 of the portion 610 of the passenger-compartment display 110 may be showing images of multimedia content, such as a movie. The first view 600 and, hence, the multimedia content may be viewed by the occupants of the vehicle 105 (including the driver) during the autonomous mode.

Referring to FIG. 6B, a second view 605 of the portion 610 of the passenger-compartment display 110 of FIG. 6A is shown. Here, the handover-detection circuit 530 may have detected a handover event that may necessitate a switch to manual mode and may have accordingly signaled the central processor 535. In response, the central processor 535 may signal the passenger-compartment display 110 to preempt or override the display of the multimedia content with images of the external environment of the vehicle 105, such as those being captured by at least some of the cameras 400. In this example, the second view 605 of the portion 610 of the passenger-compartment display 110 may show images from the cameras 400 focused on the area in front of the vehicle 105. The driver may then rely on the second view 605 of the passenger-compartment display 110 to drive the vehicle 105 in in manual mode. In addition to the portion 610 of FIG. 6B, other sections of the passenger-compartment display 110 not illustrated here can revert to showing images of the outside environment in accordance with the example above.

Referring to FIG. 6C, another second view 605 of a different portion 615 of the passenger-compartment display 110 is shown, in comparison to the portion 610 of FIG. 6B. In this example, the handover event may have already been detected, and the vehicle 105 may be returning to or may have already transitioned to the manual mode. As an option, the portion 615, in contrast to the portion 610 of FIG. 6B, may continue to display the images of the multimedia content, without being interrupted by the handover event and without the images of the multimedia content being replaced by the images of the outside environment. For example, the portion 615 of the passenger-compartment display 110 may be in an area of the passenger compartment 115 where a passenger-side window may normally be placed. As an option, the system 100 may be designed to enable one of the occupants to block the transition from the multimedia content of the other second view 605 of the portion 615 to the display of the images of the outside environment that forms the second view 605 of the portion 610 of FIG. 6B when the handover event is detected. In some cases, this feature of blocking the transition of images may be overridden by the driver or by some automated process.

If the feature is enabled, however, a virtual-side window, as described above, positioned in the affected area may remain activated to assist the driver during the manual mode. In another arrangement, in the event of a handover event, the images unrelated to the outside environment may be switched to being displayed in a less obtrusive manner, such as by increasing their transparency (previously described) or by showing them on other displays, like a portable device or one built into the back of a front seat 140.

An additional feature that may be implemented in the system 100 is a fail-safe mode. As noted earlier, the passenger compartment 115 may not contain any windows, and the driver may be completely reliant on the passenger-compartment display 110 to operate the vehicle 105. If all or at least some part of the passenger-compartment display 110 fails such that the driver is unable to safely operate the vehicle 105, the vehicle 105 may be automatically placed in the fail-safe mode. As an example, in the fail-safe mode, if the vehicle 105 is in a manual mode, the central processor 535 may immediately force the vehicle 105 into an autonomous mode. Once the transition to the autonomous mode is complete, the vehicle 105 may automatically come to a stop, maneuver to a safer area, or remain stopped, if it is already stationary when the fail-safe mode is activated.

As another example, if the vehicle 105 is already in an autonomous mode when the fail-safe mode is initiated, the vehicle 105 may remain in the autonomous mode and can continue on to its destination. The driver and other occupants of the vehicle 105, however, may be informed of the activation of the fail-safe mode based on the failure of the passenger-compartment display 110. The driver and occupants of the vehicle 105 may be notified of the fail-safe mode in any suitable fashion, such as through an indicator light (similar to a “check engine” light), one or more displayed messages (such as a display other than the passenger-compartment display 110), or audio broadcast over the speakers 510.

In another embodiment, the passenger compartment 115 may be equipped with one or more emergency windows or hatches, which may offer the driver an avenue through which the driver may see outside the passenger compartment 115 in the event of a failure of the passenger-compartment display 110. The emergency windows or hatches and other similar mechanisms may be collectively referred to as emergency optics structures.

As an example, the emergency windows may be opened and closed or may simply be permanently sealed, while the emergency hatch may be readily opened and closed. In some cases, the emergency hatch may also include a section of glass or other transparent material to enable a driver to peer through the emergency hatch if desired. As an option, the entire passenger-compartment display 110 or parts of it may be movable or collapsible to enable the driver to see through the emergency optics structures, or at least improve the ability of the driver to see through them. Any number of the emergency optics structures may be integrated into the passenger compartment 115. In either arrangement, the driver may rely on the emergency optics structures to drive the vehicle 105, such as at a reduced speed, to a safe location, possibly a short distance away. As another option, if at least some part of the passenger-compartment display 110 remained operational in the event of a failure, the functioning portion of the passenger-compartment display 110 could be used in tandem with an emergency optics structure to enable the driver to drive the vehicle 105. For example, the part of the passenger-compartment display 110 positioned in the area where the front windshield would normally be located may fail, but the virtual rear-view mirror 145 may still be operational. As such, the driver may rely on an emergency optics structure and the virtual rear-view mirror 145, which can continue to provide images from the rear of the vehicle 105, to drive the vehicle 105.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system for selectively displaying images in an autonomous vehicle, comprising:
a display that is configured to display a plurality of images, wherein at least some of the images are images of an environment external to the autonomous vehicle and are images unrelated to the environment external to the autonomous vehicle;
one or more cameras that are configured to capture the images of the environment external to the autonomous vehicle; and
a processor that is configured to:
detect a handover event associated with the operation of the autonomous vehicle; and
in response to the detection of the handover event, if the display is displaying images unrelated to the environment external to the autonomous vehicle, cause the display to display images of the environment external to the autonomous vehicle in the place of the images unrelated to the environment external to the autonomous vehicle.

2. The system of claim 1, wherein the display is comprised of one or more panels that are positioned along at least a portion of an interior perimeter of a passenger compartment.

3. The system of claim 2, wherein the passenger compartment is devoid of windows and the display is positioned along more than a majority of the interior perimeter of the passenger compartment.

4. The system of claim 1, wherein a first portion of the display corresponds to a first portion of the environment external to the autonomous vehicle and the images of the environment external to the autonomous vehicle that are displayed on the first portion of the display are based on the first portion of the environment external to the autonomous vehicle.

5. The system of claim 4, wherein the first portion of the display is assigned one of the cameras and the assigned camera provides the images of the first portion of the environment external to the autonomous vehicle.

6. The system of claim 1, wherein the images unrelated to the environment external to the autonomous vehicle include images based on multimedia content or operational information associated with the autonomous vehicle.

7. The system of claim 1, wherein the display is comprised of one or more occupant sections and wherein the images unrelated to the environment external to the autonomous vehicle that are displayed on a first occupant section of the occupant sections are different from the images unrelated to the environment external to the autonomous vehicle that are displayed on a second occupant section of the occupant sections.

8. The system of claim 1, wherein in response to the detection of the handover event, the processor is further configured to cause the images of the environment external to the autonomous vehicle to be displayed on the first occupant section and to cause the images unrelated to the environment external to the autonomous vehicle that are displayed on the second occupant section from being replaced by the images of the environment external to the autonomous vehicle.

9. A system for selectively displaying an external environment of an autonomous vehicle, comprising:
one or more cameras that are configured to capture images of the external environment of the autonomous vehicle;
a passenger-compartment display that is configured to selectively display the images of the external environment captured by the cameras and to selectively display multimedia content; and
a processor that is configured to:
detect a handover event associated with the operation of the autonomous vehicle that necessitates a form of manual intervention; and
in response to the detection of the handover event, cause the passenger-compartment display to preempt the display of the multimedia content with the display of the images of the external environment of the autonomous vehicle.

10. The system of claim 9, wherein the passenger-compartment display is a wrap-around display that is positioned along an interior perimeter of a passenger compartment of the autonomous vehicle.

11. The system of claim 9, wherein the cameras are positioned on the exterior of the autonomous vehicle and each of the cameras are further configured to capture images of a sector of the external environment of the autonomous vehicle.

12. The system according to claim 11, wherein the processor is further configured to assign each of the cameras to a corresponding portion of the passenger-compartment display and wherein the processor is further configured to cause the images of the external environment of the autonomous vehicle captured by one of the cameras to be selectively displayed on the corresponding portion of the passenger-compartment display to which that camera is assigned.

13. The system according to claim 9, wherein the passenger-compartment display includes a first section and a second section and the processor is configured to designate the first section to a first occupant of the passenger compartment and to designate the second section to a second occupant of the passenger compartment.

14. A method of selectively displaying images in an autonomous vehicle, comprising:
capturing images of the external environment of the autonomous vehicle;
during an autonomous mode, displaying images of multimedia content on a passenger-compartment display;
detecting a handover event that signals at least some manual input from an occupant of the autonomous vehicle;
in response to the detection of the handover event, pre-empting the display of the images of the multimedia content by displaying the images of the external environment of the autonomous vehicle in place of the images of the multimedia content on the passenger-compartment display; and
using the displayed images of the external environment of the autonomous vehicle to operate the autonomous vehicle manually.

15. The method of claim 14, further comprising:
displaying the images of the multimedia content on a first portion of the passenger compartment display;
displaying additional images of multimedia content on a second portion of the passenger compartment display; and
in response to the detection of the handover event, preempting the display of the images of the multimedia content on the first portion of the passenger compartment display by displaying the images of the external environment of the autonomous vehicle in place of the images of the multimedia content on the first portion of the passenger-compartment display while continuing to display the additional images of the multimedia content on the second portion of the passenger compartment display.

16. The method of claim 14, wherein the passenger-compartment display is a wrap-around display that is positioned along an interior perimeter of a passenger compartment of the autonomous vehicle.

17. The method of claim 16, wherein displaying the images of the external environment of the autonomous vehicle in place of the images of the multimedia content on the passenger-compartment display comprises displaying the images of the external environment in a 360 degree format on the wrap-around display.

18. The method of claim 14, wherein displaying the images of the external environment of the autonomous vehicle in place of the images of the multimedia content on the passenger-compartment display comprises directing a portion of the images of the external environment to a corresponding section of the passenger-compartment display and directing a separate portion of the images of the external environment to another corresponding section of the passenger-compartment display.

19. The method of claim 14, wherein using the displayed images of the external environment of the autonomous vehicle to operate the autonomous vehicle manually comprises using the displayed images of the external environment to manually drive the autonomous vehicle.

20. The method of claim 14, wherein capturing images of the external environment of the autonomous vehicle comprises capturing the images of the external environment through a plurality of cameras that are positioned along an exterior of the autonomous vehicle.
